(19) United States
(12) Patent Application Publication
(10) Pub. No.: US 2012/0105224 A1
(43) Pub. Date: May 3, 2012

(54) LIGHT EMITTING BEACON

(76) Inventor: TIMOTHY D.F. FORD, BEACONSFIELD (CA)

(21) Appl. No.: 13/288,470

(22) Filed: Nov. 3, 2011

Related U.S. Application Data
(60) Provisional application No. 61/409,758, filed on Nov. 3, 2010.

(51) Int. Cl. G08B 1/08; G08B 23/00

(52) U.S. Cl. 340/539.12; 340/573.1

(57) ABSTRACT

There is disclosed a stand-alone light emitting beacon including impact and/or pressure sensing electronics which provides an indication that the wearer has been subject to an impact or pressure capable of causing injury, such as concussion. There is also disclosed a helmet comprising a protective shell, at least one LED positioned visibly on an outer surface of the helmet, electronics comprising a microprocessor and programs for controlling an illumination of the LED and an impact sensor.

### CROSS REFERENCE TO RELATED APPLICATIONS

This application claims benefit, under 35 U.S.C. §119(e), of U.S. provisional application Ser. No. 61/409,758, filed on Nov. 3, 2010, which is incorporated herein in its entirety by reference.

### FIELD OF THE INVENTION

The present invention relates to a light emitting beacon. In particular, the present invention relates to a portable light emitting device comprising a rotary switch mounted about a translucent lens and comprising impact and/or pressure sensing electronics.

### BACKGROUND OF THE INVENTION

Sport related concussion represents the majority of brain injuries occurring in the United States with many million cases annually. Studies have shown that the probability of concussion in humans is low for accelerations of less than 700 m/s² (about 70 g's) but likely for accelerations of greater than 1000 m/s² (about 100 g's), although more recent studies have indicated that a lower threshold may be called for, especially in cases of successive blows.

In battlefield situations, soldiers are often in the proximity of percussive explosions which give rise to shock-waves of high pressure followed immediately by a negative pressure. Blast-injuries sustained by soldiers include not only concussions and the like, but also damage to the lungs and other internal organs causing internal bleeding and the like which may ultimately deprive the brain of oxygen. In many cases the injury is not readily visible and often latent, where the symptoms may not manifest for many days or months.

Concussion is diagnosed by evaluating common symptoms such as loss of consciousness (LOC), confusion, headache, nausea, blurred vision and the like. However, few or no diagnostic tools are available for determining the amount of concussive or explosive force a person may have been subject to.

### SUMMARY OF THE INVENTION

In order to address the above and other drawbacks there is disclosed a light-emitting beacon for detecting a traumatic shock comprising a housing, at least one LED, electronics for controlling an illumination of the LED, a battery for powering the electronics and the LED, and an impact sensor selected from a group comprising an accelerometer, a pressure sensor and combinations thereof, wherein when the electronics detects an acceleration using the accelerometer of greater than a threshold acceleration or a change in pressure using the pressure sensor greater than a threshold change in pressure, the electronics illuminates the LED according to an illumination which respectively indicates that the threshold acceleration has been exceeded or the threshold pressure has been exceeded.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a side perspective view of a light-emitting beacon in accordance with an illustrative embodiment of the present invention;

FIG. 2A is a sectional view of the light-emitting beacon of FIG. 1 taken along line II-II;

FIG. 2B is an exploded view of the light-emitting beacon of FIG. 1;

FIG. 3 is a top plan view of the light-emitting beacon of FIG. 1;

FIG. 4 is a schematic diagram of the electronics of a light-emitting beacon in accordance with an illustrative embodiment of the present invention; and

FIG. 5 is a graph of the estimated human tolerances for single, sharp, rising blast waves indicating pressure versus duration.

### DESCRIPTION OF ILLUSTRATIVE EMBODIMENTS

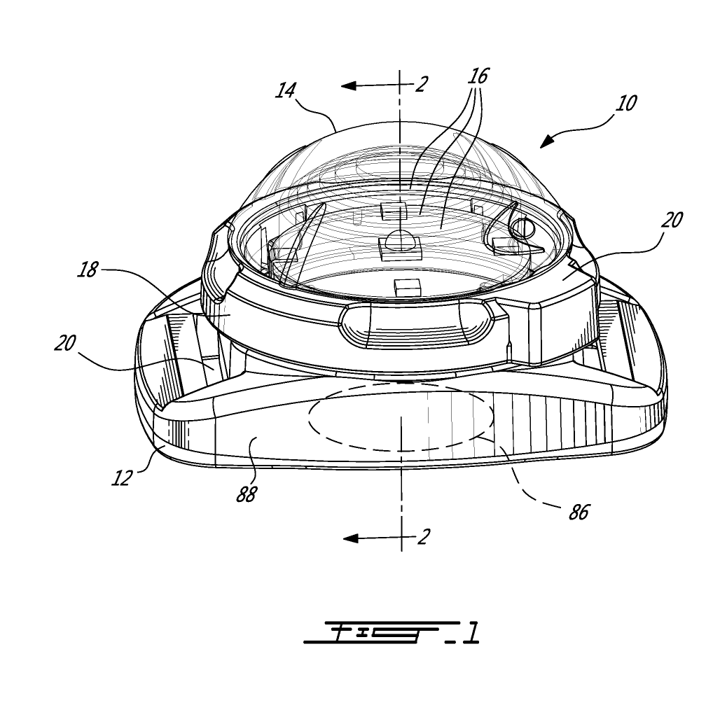

Referring now to FIG. 1, and in accordance with an illustrative embodiment of the present invention, a light emitting SMART beacon, generally referred to using the reference numeral 10, will now be described. The SMART beacon 10 comprises an opaque housing 12 fabricated from a rigid non-conductive material and a transparent or translucent lens 14 fabricated from polycarbonate or the like. The lens 14 encloses a plurality of LEDs 16 which emit light under command of electronics, also enclosed (not shown). A collar 18 is also provided which is adapted for rotation about the lens 14 and which can be actuated by a user to provide a convenient means of selecting one of a plurality of possible programs or modes under which the LEDs 16 operate. The housing 12 may also include loops as in 20 for attaching the beacon 12 to a belt or the like.

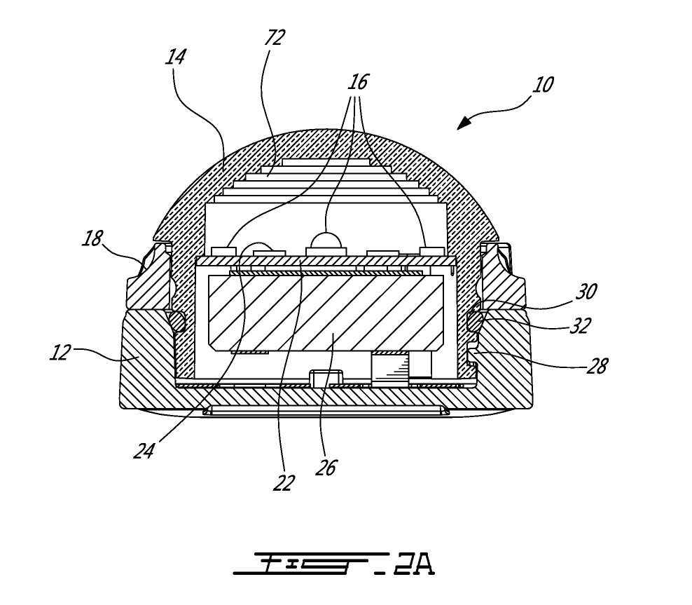

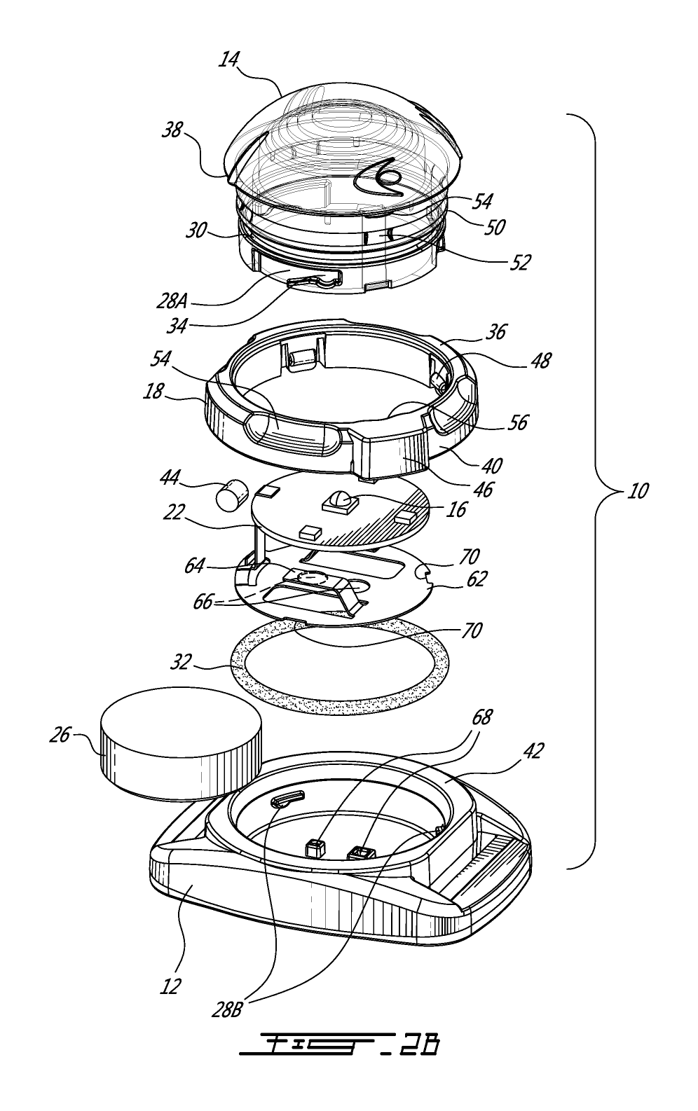

Referring now to FIGS. 2A, as discussed above the lens 14 encloses the plurality of LEDs 16 which are mounted on a Printed Circuit Board (PCB) 22 onto which electronics as in 24 are also mounted. The electronics 24 and the LEDs 16 are powered by a battery 26. As will be discussed in more detail below, the lens 14 is releasably secured to the opaque housing 12 by a locking mechanism 28. A groove 30 is provided in the lens 14 for receiving a sealing O-ring 32 between the housing 12 and the lens 14 to prevent the egress of water and other detritus into the enclosure formed by the lens 14 when secured to the housing 12.

Referring to FIG. 2B, on assembly the locking mechanism 28 is engaged by aligning a lens mounted part 28A of the mechanism with a housing mounted tab 28B of the mechanism and rotating the lens 14 vis-à-vis the housing 12 thereby inserting the housing mounted tab 28B into the tab receiving portion of the lens mounted part 28A. The lens mounted part 28A is moulded or otherwise formed to include an enlarged end 34 thereby securely engaging the lens 14 with the housing 12. Providing a mechanism 28 for releasably securing the lens 14 to the housing 12 allows the battery 26 to be accessed for exchange or reversal and the like.

Still referring to FIG. 2B, during assembly of the beacon 10, the collar 18 is placed about the lens 14 such that once assembled an upper edge 36 of the collar 18 butts against a shoulder 38 formed in the lens and a lower edge 40 of the collar 18 rests against an upper edge 42 of the housing 12. In this manner, the lens 14 acts as a hub about which the collar 18 rotates. In order to determine the current position of the collar 18 relative to the housing 12 and lens 14, illustratively a magnet 44 is imbedded in the collar 18 and magnet position sensing electronics, for example read switches or hall effect sensors or the like (all not shown) are mounted on the PCB 22 to determine the current position of the magnet 44. In this manner the current position of the collar 18 relative to the housing 12 and lens 14 can be provided to the electronics 24 thereby allowing user selection of beacon operation. Illustratively, the electronics are capable of determining four different positions of the collar 18 relative to the housing 12 and lens 14, thereby providing four (4) operational settings, typically one of which is an “off” setting.

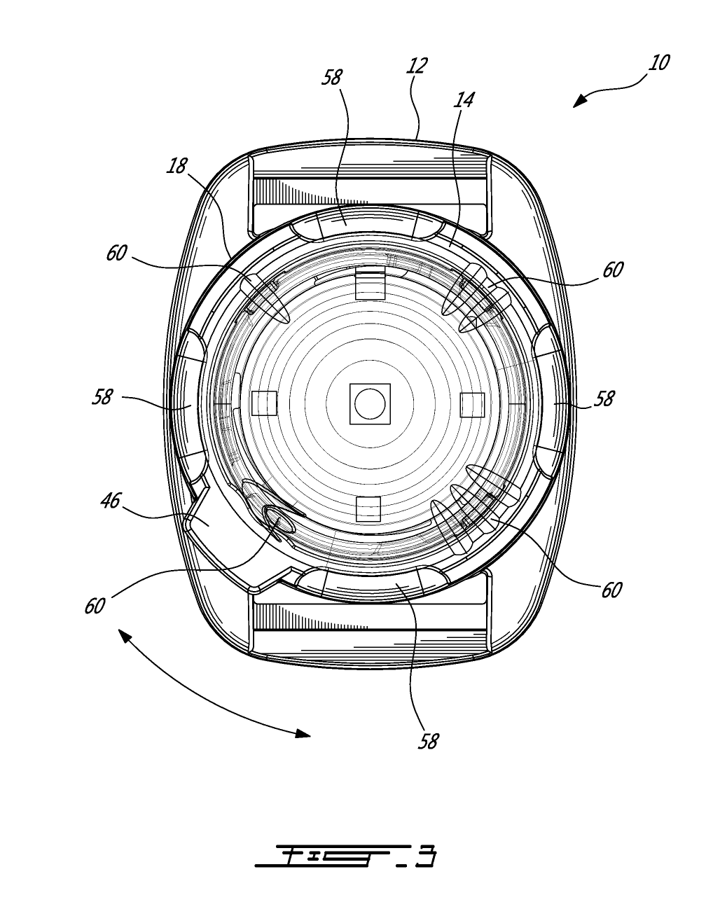

Referring now to FIG. 3 in addition to FIG. 2B, in order to provide the user with feed back to the current position of the collar 18 relative to the housing 12 and lens 14, the collar 18 also includes a protruding stud 46. Additionally, the inside of the collar is provided with a flexible protuberance 48 which is adapted to move along a corresponding groove 50 formed in the lens 14. A plurality of indentations 52 (illustratively 4) are provided in the groove 50 at spaced intervals which engage the flexible protuberance 48 thereby providing the user with mechanical feed back that the collar 18 has reached one of the predetermined mode selecting positions. Additionally, the lens 14 includes a raised boss 54 which engages with a notch 56 formed in the collar 18, for example when the beacon 10 is in the “powered off” position thereby providing distinguishable feedback (e.g. a “double click”) that the selected position is in the “powered off” position, while reducing the chance that the beacon 10 is inadvertently turned on by the user. A series of additional indentations as in 58 are provided on the outside of the collar 18 to provide for better grip when rotating the collar 18 about the lens 14.

Still referring to FIG. 3, as the beacon 10 is often worn in positions where the user is unable to see it (for example, on the top of a helmet worn on the user's head) or is used to provide infrared illumination in situations of low visibility, a series of brail like raised markers as in 60 are provided in the surface of the lens 14, which when aligned with the stud 46 provide tactile feedback as to the position, and therefore the program mode, that the beacon 10 is currently being operated in. Illustratively the raised markers as in 60 are large enough (at least about 1.5 mm) such that they can be established when the user is wearing gloves or the like.

Referring back to FIG. 2B, the battery 26 is retained within a conductive cage 62 which is interconnected with the PCB 22. The lower plate 64 of the conductive cage 62 comprises a pair of holes 66 machined therein which are adapted to fit during assembly with a pair of corresponding raised bosses 68 moulded or otherwise formed in the electronics receiving cavity in the housing 12. The machined lower plate 64 also comprises a series of notches 70 around a periphery thereof adapted to fit over the housing mounted tab 28B and thereby simplifying installation of the conductive cage 62 in the electronics receiving cavity in the housing 12.

Referring back to FIG. 2A, the inner surface 72 of the lens 14 is moulded or otherwise formed as a series of concentric circles, thereby forming a variant of a Fresnel type lens which serves to better disperse the light emitted by the one or more LEDs 16.

Still referring to FIG. 2A, as discussed above, the electronics 24 of the beacon are mounted on the PCB 22 and powered by the battery 26. In this regard, the battery may be reversed such that the positive pole is facing respectively towards or a way from the PCB 22. As will be seen below, in this manner the electronics 24 can remain powered while at the same time providing an additional input (the polarity of the battery) to the electronics 24, thereby increasing the potential number of settings available to the user.

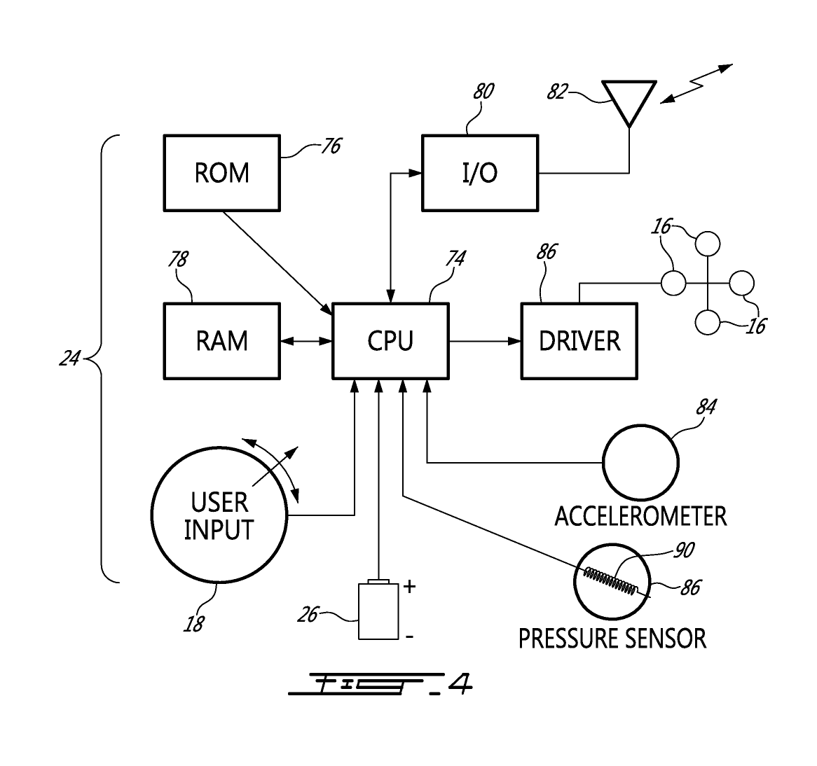

Referring now to FIG. 4, the electronics 24 illustratively comprise a CPU, 74, and ROM 76 and RAM 78 for storing control programs for operating beacon 10 and user settings and the like. Additionally there is illustratively provided a Radio Frequency (RF) interface 80 comprising an antenna 82, an accelerometer 84, such as MEMS accelerometers, MEMS type impact sensors, piezoelectric membranes, Force-Sensitive-Resistors (FSRs) or the like, for detecting impacts and the like, a pressure sensor 86 for detecting changes in pressure and a driver interface 86 for driving the one or more LEDs 16. The one or more LEDs 16 are driven in response to control information generated by the CPU 74 according to for example, programs and other data stored in the ROM 76 and RAM 78, user inputs received via the position of the collar 18, the orientation/polarity of the battery as well as other information received via the RF interface 80.

Referring back to FIG. 1, the pressure sensor 86 is preferably moulded into the housing 12 and comprises a thin outer diaphragm 88 which flexes correspondingly with sharp increases or decreases in pressure. Referring back to FIG. 4, the pressure sensor 86 would typically include a transducer 90 such as a network of strain gauges or the like, which senses movement on the outer diaphragm 88 and converts this into pressure reading(s).

In an alternative embodiment the pressure sensor 86 could comprise an external sensor (not shown) in communication with the remaining electronics 24 through a suitable communications interface (also not shown).

Still referring to FIG. 4, using the accelerometer 84, the electronics 24 are able to detect and collect data as to the strength of traumatic shock events, or impacts, which can subsequently be used to automatically activate the LEDs 16 of the SMART beacon 10. Still referring to FIG. 4, the electronics 24 can be programmed to operate in one of a number of modes depending on the application. For example, in one embodiment the electronics may trigger the LEDs 16 to be illuminated, for example using a particular colour of illumination or flashing sequence, in response to a detected impact and according to the strength of the impact. For example, in the case of an acceleration of over 70 gs, which is typically indicated as a the lower threshold of onset of concussion, the LEDs 16 could be illuminated to indicate the possibility of a concussion in the wearer. In the case of an acceleration of over 80 gs, for example, the LEDs 16 could be illuminated to indicate that a concussion in the wearer is probable. In the case of an acceleration of over 100 gs, for example, the LEDs 16 could be illuminated in a manner to indicate the that the wearer is more than likely to be concussed. Additionally, the frequency of the flashing may change based on a relative severity of the impact.

Additionally, the electronics 24 can additionally or alternatively be programmed to store the strengths of successive impacts and include programs to evaluate a cumulative effect, for example by summing the successive impacts. For example, if the wearer was subject to ten (10) accelerations in excess of 50 gs, further observation might be warranted, and the LEDs could be illuminated in a manner, for example using a particular colour of illumination or flashing sequence to indicate this.

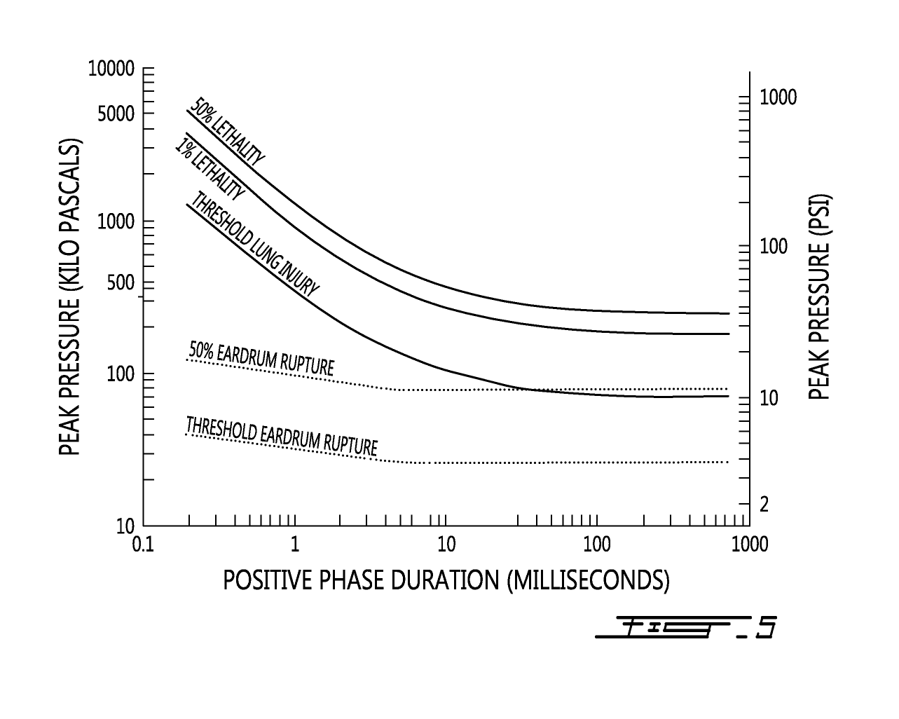

Referring now to FIG. 5 in addition to FIG. 4, using the pressure sensor 86, the electronics 24 are able to detect and collect data as to the strength and duration of shock waves. High-velocity shock waves which exert a local pressure in excess of about 40 PSI may be lethal. However, the extent of the injury sustained is dependent on a number of factors such as the peak pressure of the shock wave and the duration (positive phase duration) of the shock wave. For example, in the case of a shock wave 40 PSI, which is typically indicated as a lower threshold of lethal shock waves, the LEDs 16 could be illuminated to indicate the possibility of death or significant injury in the wearer. In the case of a shock wave of over 10 PSI, for example, the LEDs 16 could be illuminated to indicate that lung injury in the wearer is possible. In the of shock wave of over 10 PSI, for example, the LEDs 16 could be illuminated in a manner to indicate that the wearer is more than likely to suffer from loss of hearing.

Still referring to FIG. 4, in addition to illuminating one or more of the LEDs responsive to accelerations or shock waves measured respectively by accelerometer 84 and the pressure sensor 86, in particular cases an RF transmission indicating potential injury can be transmitted via the RF interface 80 to a suitably equipped receiver (not shown) such as suitably equipped Personal Digital Assistant (PDA) or the like held by a medic or team doctor or the like. Such an RF transmission could include, for example, a unique ID identifying the particular light emitting beacon 10 initiating the RF transmission as well a description of the event which led to the transmission. In a particular embodiment, a second light emitting beacon as in 10 could act as the receiver of the RF transmission and illuminate itself appropriately in response to reception of the RF-transmission, for example by changing colour, emitting a flashed sequence, or both. This could provide, for example, a “silent” indication to a leader or commander in a group setting that another who is not in visual range has been subject to a traumatic event or the like. Alternatively, the RF-transmission could be as the result of the wearer of the beacon 10 rotating the collar 18 from a first position to a second indication, thereby providing an indication to any receiving the RF-transmission that the wearer's status has changed.

Although the present invention has been described hereinabove by way of specific embodiments thereof, it can be modified, without departing from the spirit and nature of the subject invention as defined in the appended claims.

What is claimed is:

1. A stand-alone light-emitting beacon for detecting a traumatic shock comprising:
a housing;
at least one LED;
electronics comprising a microprocessor and programs for controlling an illumination of said LED and comprising an impact sensor; and
a battery for powering said electronics and said LED;
wherein when said electronics detects an impact using said impact sensor of greater than a threshold impact, said electronics illuminates said LED according to an illumination which respectively indicates that said threshold impact has been exceeded.

2. The light-emitting beacon of claim 1, wherein said impact sensor comprises an accelerometer and further wherein said threshold impact comprises a threshold acceleration.

3. The light-emitting beacon of claim 1, wherein said impact sensor comprises a pressure sensor and further wherein said threshold impact comprises a threshold pressure.

4. The light-emitting beacon of claim 3, wherein said threshold pressure is a negative pressure.

5. The light-emitting beacon of claim 1, further comprising a translucent lens covering said LED.

6. The light-emitting beacon of claim 1, wherein said electronics illuminates said LED according to an illumination which indicates an amount by which said threshold acceleration has been exceeded or an amount by which said threshold pressure has been exceeded.

7. The light-emitting beacon of claim 5, further comprising a rotary switch configured for rotation about said translucent lens and further wherein rotation of said rotary switch to one of a plurality of predetermined positions selects respectively one of a plurality of predetermined modes of beacon operation, and wherein one of said modes of operation is an off mode.

8. The light-emitting beacon of claim 1, further comprising an RF interface and wherein when said impact sensor detects an impact greater than said threshold impact, said electronics transmits an indication using said RF interface com prising a unique ID associated with the beacon which indicates that said threshold impact has been exceeded.

9. The light-emitting beacon of claim 2, wherein said threshold acceleration equals or exceeds an acceleration causing injury to a person wearing the beacon.

10. The light-emitting beacon of claim 3, wherein said threshold pressure equals or exceeds a pressure capable of causing injury to a person wearing the beacon.

11. The light-emitting beacon of claim 2, wherein said threshold acceleration is between 70 gs and 100 gs.

12. The light-emitting beacon of claim 11, wherein said threshold acceleration is about 80 gs.

13. The light-emitting beacon of claim 3, wherein said threshold pressure is between 10 PSI and 40 PSI.

14. The light-emitting beacon of claim 3, wherein said threshold pressure includes a peak pressure component and a positive phase duration component and wherein said threshold pressure is greater than a pressure that indicates lung injury.

15. The light-emitting beacon of claim 14, wherein said threshold pressure is greater than a pressure that indicates 1% lethality.

16. The light-emitting beacon of claim 15, wherein said threshold pressure is greater than a pressure that indicates 50% lethality.

17. The light-emitting beacon of claim 1, wherein said electronics further comprise a data store for storing a plurality of sensed impacts and said programs comprise a program for summing said plurality of sensed impacts, wherein when said summed sensed impacts exceed a predetermined summed impact threshold, said electronics illuminates said LED according to an illumination which indicates that said summed threshold impact has been exceeded.

18. A helmet comprising:
a protective shell configured for encircling at least a portion of a wearer's head,
at least one LED positioned visibly on an outer surface of the helmet;
electronics comprising a microprocessor and programs for controlling an illumination of said LED and an impact sensor; and
a battery for powering said electronics and said LED;
wherein when said electronics detects an impact using said impact sensor of greater than a threshold impact, said electronics illuminates said LED according to an illumination which respectively indicates that said threshold impact has been exceeded.

19. The helmet of claim 18, wherein said impact sensor comprises an accelerometer and further wherein said threshold impact comprises a threshold acceleration.

20. The helmet of claim 18, wherein said impact sensor comprises a pressure sensor and further wherein said threshold impact comprises a threshold pressure.
